(19) United States
(12) Patent Application Publication
(10) Pub. No.: US 2008/0232635 A1
(43) Pub. Date: Sep. 25, 2008

(54) Loudspeaker with an Acoustic Membrane

(75) Inventor: David Magda Eddy Corynen, Dendermonde (BE)

Correspondence Address: SHEEHAN PHINNEY BASS & GREEN, PA;c/o PETER NIEVES, 1000 ELM STREET, MANCHESTER, NH, 03105-3701, US

(73) Assignee: PSS Belgium N.V. a corporation

(21) Appl. No.: 11/575,772

(22) PCT Filed: Sep. 29, 2005
(86) PCT No.: PCT/IB2005/053214

§ 371 Date: Mar. 22, 2007

(30) Foreign Application Priority Data
Sep. 30, 2004 (EP) 04104782.0

(51) Int. Cl. H04R 1/00

(52) U.S. Cl. 381/398

(57) ABSTRACT

A loudspeaker (1) having a piston resonance frequency (f₀) is disclosed. The loudspeaker comprises (1) an acoustic member (4) intended to operation in piston mode and provided with a plate-like body (8), (2) a drive unit (6) for translating the acoustic member along a translation axis (x) oriented substantially perpendicular to a main face (8a) of the plate-like body, and (3) a frame (2) from which the acoustic member is flexibly suspended. The plate-like body is an easy-to-manufacture polycarbonate or polymethylmethacrylate sheet (8′) having a first break-up frequency (f₁) which is higher than or equal to two times the piston resonance frequency (f₀).

The invention relates to a loudspeaker provided with an acoustic member intended for operation in piston mode and having a piston resonance frequency (f₀) and comprising a plate-like body; a drive unit for translating the acoustic member along a translation axis oriented substantially perpendicular to a main face of the plate-like body; and a frame from which the acoustic member is flexibly suspended.

U.S. Pat. No. 6,095,280 discloses an excursion loudspeaker which is provided with a flat composite diaphragm. This diaphragm is supported by a frame by means of a roll-suspension and a spider-suspension. An electro-magnetic driver having a voice-coil and a permanent magnet serves for translating the composite diaphragm along a translation axis. The composite diaphragm is a so-called dual-skin diaphragm, i.e. a diaphragm having a core positioned between two skins. Such a diaphragm is rather manufacture-unfriendly and thus expensive.

For this reason it is an object of the invention to provide a loudspeaker of the kind as described in the opening paragraph, which has an adequate but easy-to-manufacture acoustic member.

This object is achieved by the loudspeaker according to the invention, which loudspeaker is provided with:
an acoustic member intended for operation in piston mode, and having a piston resonance frequency (f₀) which acoustic member comprises a plate-like body;
a drive unit for translating the acoustic member along a translation axis, which axis is oriented substantially perpendicular to a main face of the plate-like body; and
a frame from which the acoustic member is flexibly suspended, and
   which loudspeaker is characterized in that the plate-like body is a sheet of polycarbonate (PC) or polymethylmethacrylate (PMMA), the sheet having a first break-up frequency (f₁), which frequency is at least, i.e. equal to or higher than, two times the piston resonance frequency (f₀), thus f₁≧2f₀.

Experimentally it has appeared, by surprise, that polycarbonate sheets and polymethylmethacrylate sheets are very well suitable as piston membrane in the lower and middle frequency ranges, provided that the first break-up frequency (f₁) is at least two times the piston resonance frequency (f₀). The values of these frequencies are dependent on the thickness of the sheet. The loudspeaker according to the invention has a minimum piston operation bandwidth of one octave and thus the acoustic member is able to operate perfectly in piston mode at lower frequencies. Above the first break-up frequency different higher-order break-ups are transformed into acoustical energy giving the loudspeaker a useful operation in this frequency area. There is no requirement to optimize the acoustic member for operation above the first break-up frequency (f₁). Electrical equalizing of the audio signal may be applied if a balanced acoustical output in this frequency area is desired.

The acoustic membrane applied in the loudspeaker according to the invention has the required properties, such as density and stiffness, to be able to move like a piston with a low piston resonance frequency, even if applied into relatively small enclosures.

A further advantage of making use of polycarbonate and polymethylmethacrylate sheets is that such sheets are easy-to-manufacture in different thicknesses, so that manufacturing the plate-like body of an acoustic member from such a sheet is rather inexpensive. Moreover, said plastic materials are available in a variety of colors and transparencies. Summarizing it can be concluded that the insight that polycarbonate and polymethylmethacrylate sheets are suitable for forming plate-like acoustic piston bodies gives considerable freedom in designing excursion loudspeakers.

It is to be noted that it is known from EP-A 1 084 592 to form a panel-form member of a distributed mode loudspeaker from polycarbonate. In this kind of loudspeakers a vibration transducer is used to apply bending wave energy to the panel-form member to cause it to resonate to act as an acoustic radiator. The mechanical and acoustical demands made upon this kind of member is totally different from the demands made upon acoustic piston members. EP-A 1 084 592 does not teach anything about acoustic piston members. Contrary thereto, EP-A 1 084 592 teaches to clamp or restrain the marginal portions of the panel-form member and thus teaches to prevent piston operation.

In an embodiment of the loudspeaker according to the invention the main face of the plate-like body has a central longitudinal axis and a shorter central latitudinal axis. Such an embodiment has preferably a rectangular or a more or less elliptical contour. In another preferred embodiment the plate-like body has a circular contour.

An embodiment of the loudspeaker according to the invention characterized is that the plate-like body is substantially flat, i.e. flat or practically flat.

A minimum sheet thickness (t) is required for a flat plate-like body to obtain sufficient stiffness to move as an acoustic piston body over a useful frequency bandwidth before the first break-up frequency (f₁) is reached.

The frequency of the first break-up mode of a rectangular mode is oriented along the central longitudinal axis and can be defined as:

$${f}_{1} ≅ \frac{t}{{l}^{2}} \sqrt{\frac{E}{ρ}} , wherein$$

t=thickness (m)
l=length (m).
E=elasticity modulus (Pa)
ρ=volume density (kg/m³)

The frequency of the first break-up mode of a circular shaped body can be defined as:

$${f}_{1} ≅ \frac{0.4 t}{{r}^{2}} \sqrt{\frac{E}{ρ}} , wherein$$

t=thickness (m)
r=radius (m)
E=elasticity modulus (Pa)
ρ=volume density (kg/m³).

For the sake of clarity it is noted that the first break-up frequency (f₁) is meant to be the lowest frequency at which the plate-like body does not act as a pure piston.

The piston resonance frequency of the acoustic member is defined as:

$${f}_{0} = \frac{1}{2 π} \sqrt{\frac{k}{m}} , wherein$$

k=total stiffness (N/m)
m=total mass (kg).

The total stiffness (k) is defined by the suspension of the acoustic member in the loudspeaker frame. The total mass (m) is defined by the total moving mass of the loudspeaker. This mass is partly determined by the required stiffness of the plate-like body and thus by the minimally required sheet thickness (t). On the other hand the frequency distance between the piston resonance frequency (f₀) and the first break-up frequency (f₁) can be changed by changing the thickness (t). An increased thickness (t) lowers the piston resonance frequency (f₀) and heightens the first break-up frequency (f₁) and thus increases the piston operation bandwidth. In other words the thickness (t) is a parameter for determining the piston operation frequency bandwidth of the loudspeaker according to the invention.

Preferably, the loudspeaker according to the invention is provided with a limiter for limiting a translation movement of the acoustic member along the translation axis. In this way damages due to too long strokes of the acoustic member are prevented.

In a preferred embodiment the drive unit comprises a stationary drive section secured to the frame and a translatable drive section secured to the acoustic member. The drive unit may be of the well-known electromagnetic type, i.e. the translatable drive section is provided with an energizing coil and the stationary part is provided with a permanent magnet, or vice versa.

The embodiment of the loudspeaker according to the invention which has a relatively long central longitudinal axis with regard to the central latitudinal axis, is preferably provided with two stationary subsections for cooperation with translatable subsections, wherein one pair of stationary and translatable subsections is located at one side of the control latitudinal axis, in a region around the center of one half of the central longitudinal axis, and the other pair of stationary and translatable subsections is located at the other side of the central latitudinal axis, in a region around the center of the other half of the central longitudinal axis. In this way a sufficient piston operation frequency bandwidth for this kind of embodiment is guaranteed. Moreover, a more stable piston movement is obtained because of avoiding rocking of the acoustic member.

For some applications, it may be desirable to enhance the stiffness of the plate-like body by means of a stiffening means, preferably without significantly changing the moving mass. This can be done by adding stiffening objects, such as reinforcing ribs or an additional lightweight stiff or solid panel, such as a glass plate extending parallel to the main face. Another option is to give the plate-like body a slightly bent shape, e.g. a more or less dome-like shape.

The loudspeaker according to the invention is suitable for sound registration in TV-, hifi-, home-, automotive- and multimedia-audio systems.

The invention also relates to a plate-like body which presents features of the plate-like body disclosed in this paper and which is designated and constructed and evidently intended for use in the loudspeaker according to the invention.

The invention further relates to an acoustic member provided with, including existing of, the plate-like body according to the invention.

With regards to the Claims it is noted that various combinations of embodiments and features as disclosed in the Claims are possible and intended within the scope of the invention. Such combinations are thus part of the invention.

The invention will now be described in more detail, by way of example, with reference to the drawings, in which identical or corresponding parts bear the same reference numerals. In the drawings

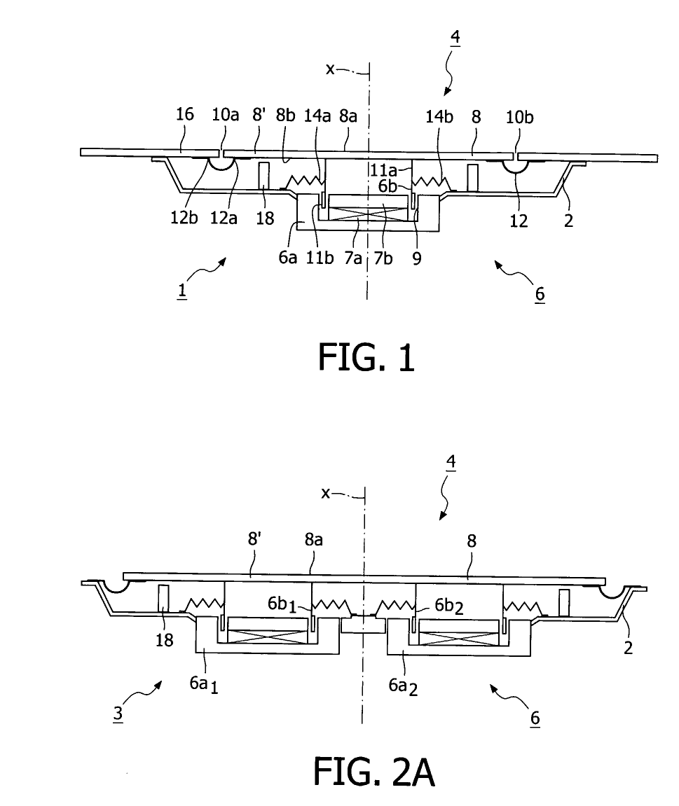

FIG. 1 shows diagrammatically in cross-section a first embodiment of the loudspeaker according to the invention,

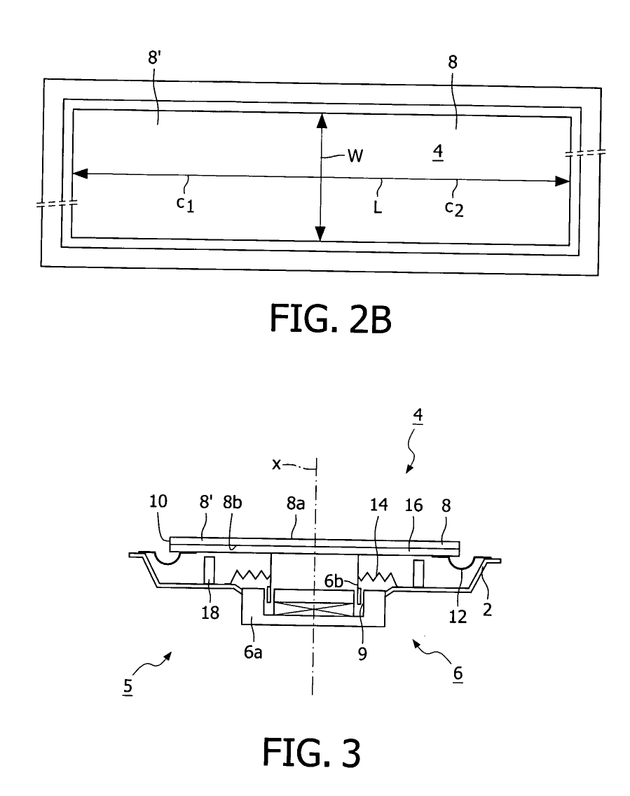

FIG. 2A shows diagrammatically in cross-section a second embodiment of the loudspeaker according to the invention,

FIG. 2B shows diagrammatically in top-view the embodiment of FIG. 2A, and

FIG. 3 shows diagrammatically in cross-section a third embodiment of the loudspeaker according to this invention.

The loudspeaker 1 depicted in FIG. 1 comprises a frame 2, an acoustic member 4 and an electromagnetic drive unit 6. The acoustic member 4 has an in principle flat plate-like body 8 formed by a polycarbonate sheet 8′. The plate-like body 8 is provided with two parallel main faces 8a, 8b which have rectangular contours 10a, respectively 10b. The drive unit 6, which is meant for translating the acoustic member 4 along a translation axis x oriented perpendicular to the main faces 8a, 8b, consists of a stationary drive section 6a secured to the frame 2 and a translatable drive section 6b secured to the acoustic member 4. The stationary drive section 6a comprises a magnet system having a permanent magnet 7a and a magnetic yoke 7b forming an air gap 9. The translatable drive section 6b comprises a coil system having a coil support 11a and a voice coil 11b extending in the air gap 9. Such a drive unit is known per se and for this reason it is not further explained here. Alternatively, the stationary drive section may comprise the coil system and the translatable drive section may comprise the magnet system.

The loudspeaker 1 is provided with a suspension system having two flexible suspensions 12 and 14. The suspension 12 is a so-called roll-suspension having a ring-shaped arcuate roll known per se and made of e.g. rubber or foam. Its inner circumferential edge 12a is fixed to the acoustic member 4, while its outer circumferential edge 12b is connected to the frame 2 via a baffle 16. The suspension 14 is a so-called spider-suspension having a ring-shaped corrugated body known per se and made of e.g. textile. The inner circumferential edge 14a of the suspension 14 is connected to the acoustic member 4 via the coil support 1a and the outer circumferential edge 14b is fixed to the frame 2. The loudspeaker 1 is provided with one or more limiters 18, in this example four, in order to limit the inwardly directed axial excursion of the acoustic member 4.

A practical example of the loudspeaker 1 has the following parameters. The polycarbonate sheet 8′ forming the plate-like body 8 has a thickness of 1.55 mm, a length of 76 mm and a width of 46 mm. The elasticity modulus E is about 3 Gpa and the volume density ρ is about 1200 kg/m³. The total moving mass m, i.e. the assembled mass of the acoustic member 4, the translatable drive section 6b and the movable portions of the suspensions 12 and 14, is 7.5 g. The total stiffness k, i.e. the stiffness formed by the stiffness of the roll-suspension and the stiffness of the spider-suspension, is 3000N/m.

The piston resonance frequency (f₀) is about 100 Hz, while the first break-up mode frequency is about 425 Hz. Thus the useful piston operation frequency area of this loudspeaker 1 is in this example about 2 octaves.

A similar example, wherein instead of a polycarbonate sheet a polymethylmethacrylate sheet is used, has comparable values for the elasticity modulus and the volume density.

The loudspeaker 3 depicted in the FIGS. 2A and 2B is provided with an acoustic member 4 intended for operation in piston mode, a drive unit 6 for translating the acoustic member 4 along a translation axis x, and a frame 2 from which the acoustic member 4 is suspended. The acoustic member 4 is constituted by a plate-like body 8 formed by a polycarbonate sheet 8′. The translation axis x is oriented perpendicular to a main face 8a of the plate-like body 8. The main face 8a is rectangular and has a central longitudinal axis L and a central latitudinal axis W. In this example the longitudinal axis L has a relatively long length dimension compared to the length dimension of the latitudinal axis W. The drive unit 6 comprises a stationary drive action secured to the frame 2 and a translatable drive section secured to the acoustic member 4. The stationary drive section has two stationary subsections 6a₁ and 6a₂ for cooperation with translatable subsections 6b₁ and 6b₂ of the translatable drive section. A pair of subsections which is formed by the stationary subsection 6a₁ and the translatable subsection 6b₁ is located at one side of the central latitudinal axis W; particularly in a region around the center c₁ of one half of the central longitudinal axis L. The other pair of subsections 6a₂ and 6b₂ is located at the other side of the axis W; more specific in a region around the center c₂ of the other half of the axis L.

The loudspeaker 3 is provided with a suspension system consisting of a flexible suspension 12 in the form of a so-called roll-suspension and a pair of flexible suspensions 14 in the form of so-called spider-suspensions.

In operation, the plate-like body 8 has a first break-up frequency (f₁) which is higher than two times the piston resonance frequency (f₀).

The loudspeaker 5 depicted in FIG. 3 is provided with piston body for reproducing sound, further mentioned acoustic member 4 a frame 2 from which the acoustic member 4 is flexibly suspended and a drive unit 6. The drive unit 6 is intended for translating the acoustic member along a translation axis x.

The acoustic member 4 comprises a plate-like body 8 being a polycarbonate sheet 8′ which has a first break-up frequency (f₁) which frequency is at least two times the piston resonance frequency (f₀) of the loudspeaker. The plate-like body 8 has two main faces 8a and 8b of circular contour 10.

In this example the plate-like body 8 is provided with a stiffening device in order to enhance the stiffness of the plate-like body 8 and thus of the acoustic member 4. The stiffening device is formed by reinforcing strips or beams 16 provided on the main face 8b, near the contour 10. Optionally, the main face 8a may be provided with a finishing cover plate, such as a thin glass plate, e.g. with a thickness of 0.4 mm.

It is to be noted that it is within the scope of the invention to vary from the depicted examples. It is e.g. within the scope of to make use of a slightly bent body.

1. A loudspeaker provided with:
an acoustic member intended for operation in piston mode, having a piston resonance frequency (f₀) and comprising a plate-like body;
a drive unit for translating the acoustic member along a translation axis which is oriented substantially perpendicular to a main face of the plate-like body; and
a frame from which the acoustic member is flexibly suspended, wherein the plate-like body is a sheet of polycarbonate or polymethylmethacrylate, the sheet having a first break-up frequency (f₁) which is two times or higher than two times the piston resonance frequency (f₀).

2. A loudspeaker as claimed in claim 1, wherein the main face of the plate-like body has a central longitudinal axis and a central latitudinal axis which is shorter than the central longitudinal axis.

3. A loudspeaker as claimed in claim 1, wherein the main face of the plate-like body has a circular contour.

4. A loudspeaker as claimed in claim 1, wherein the plate-like body is substantially flat.

5. A loudspeaker as claimed in claim 1, wherein the frame is provided with a limiter for limiting a translation movement of the acoustic member along the translation axis.

6. A loudspeaker as claimed in claim 1, wherein the drive unit comprises a stationary drive section secured to the frame and a translatable drive section secured to the acoustic member.

7. A loudspeaker as claimed in claim 6, wherein the main face of the plate-like body has a central longitudinal axis and a central latitudinal axis which is shorter than the central longitudinal axis, and wherein the stationary drive section has two stationary subsections for cooperation with translatable subsections of the translatable drive section, and wherein one pair of stationary and translatable subsections is located at one side of the central latitudinal axis, in a region around the centre of one half of the central longitudinal axis, and the other pair of stationary and translatable subsections is located at the other side of the central latitudinal axis, in a region around the centre of the other half of the central longitudinal axis.

8. A loudspeaker as claimed in claim 1, wherein the plate-like body is provided with a stiffening means.

9. A plate-like body presenting all the features of the plate-like body disclosed in any one of the preceding claims and being thus constructed and evidently intended for use in the loudspeaker as claimed in claim 1.

10. An acoustic member provided with the plate-like body as claimed in claim 9.
